(19) United States
(12) Patent Application Publication
(10) Pub. No.: US 2009/0270208 A1
(43) Pub. Date: Oct. 29, 2009

(54) COAXIAL ELECTRICAL ACTUATOR FOR CONTINUOUSLY VARIABLE TRANSMISSION

(76) Inventor: John M. Starkey, West Lafayette, IN (US)

Correspondence Address: BAHRET & ASSOCIATES, 320 NORTH MERIDIAN STREET, SUITE 510, INDIANAPOLIS, IN, 46204, US

(21) Appl. No.: 12/168,676

(22) Filed: Jul. 7, 2008

Related U.S. Application Data
(62) Division of application No. 11/120,148, filed on May 2, 2005, now abandoned.
(60) Provisional application No. 60/567,468, filed on May 3, 2004.

(51) Int. Cl. F16H 9/16; F16H 55/56

(52) U.S. Cl. 474/11; 474/8

(57) ABSTRACT

An electrically actuated continuously variable transmission with a first pulley having a first pulley portion for fixed connection to an engine shaft and an axially movable second pulley portion for placement about the engine shaft. An electric actuator coaxially coupled to the second pulley portion moves the second pulley portion with respect to the first pulley portion when the electric actuator moves the second pulley portion to change spacing between the first and second pulley portions.

### CROSS-REFERENCE TO RELATED APPLICATIONS

This application is a division of U.S. patent application Ser. No. 11/120,148, filed May 2, 2005. This application claims the benefit of U.S. Provisional Patent Application Ser. No. 60/567,468, filed May 3, 2004, which application is hereby incorporated by referenced along with U.S. patent application Ser. No. 11/415,391, filed May 1, 2006.

### TECHNICAL FIELD OF THE INVENTION

This invention relates generally to transmissions, and more particularly to methods and apparatus for actuation of continuously variable transmissions.

### BACKGROUND OF THE INVENTION

Transmissions are devices that transform the speed and torque in vehicles using gears, belts, or other drive components. Most transmission designs use discrete speed ratios: low ratios for acceleration, hill climbing, and heavy hauling, and high ratios for higher-speed travel. They use multiple parallel gear sets between input and output shafts. By changing which gear set carries the loads between the shafts, the speed ratio between the input and output shafts is altered.

Transmissions have also been designed that are continuously variable (CVTs). These generally use friction to transfer load from an input shaft to an output shaft. By altering the radial position of friction rollers, belts, or other components, the speed ratio is changed.

A typical CVT design 10 is shown in FIGS. 1 and 2. It uses a driving (primary) pulley 12, a wide v-belt 14, and a driven (secondary) pulley 16. The speed ratio is adjusted by altering the width of the driving 12 and driven 16 pulleys, so that the v-belt 14 contacts at varying radii on the pulleys 12 and 16. FIG. 1 shows the CVT 10 operating at a lower speed ratio where the driving pulley halves 22 and 24 are separated and the v-belt 14 contacts the pulley halves 22 and 24 at a small radius. The driven pulley halves 18 and 20 are squeezed together by a spring under these conditions, forcing the belt 14 at the output end to contact at a large radius. This configuration offers maximum torque magnification and speed reduction. FIG. 2 shows the CVT operating in a higher speed ratio where the pulley halves 22 and 24 of the driving pulley 12 are positioned close together, forcing the v-belt 14 to contact the pulley halves 22 and 24 at a larger radius and increasing the velocity of the v-belt 14. The increased velocity of the v-belt 14 works against the spring force of the driven pulley 16, forcing the driven pulley halves 18 and 20 apart where the v-belt 14 contacts the driven pulley halves 18 and 20 at a smaller radius. This configuration offer maximum speed magnification.

Most current CVTs rely upon fixed-design mechanical or hydraulic actuation that cannot be easily changed to respond to differing demands, such as varying vehicle cargo loads and operator performance demands. Accordingly, there is need for a CVT actuation system that is more flexible and adaptable than the current state of technology.

### SUMMARY OF THE INVENTION

According to one aspect of the present invention, a coaxial electrical actuator is provided for a continuously variable transmission with first and second pulleys interconnected by a belt. The first pulley is connected to an engine shaft and has a first pulley portion and a second pulley portion axially movable with respect to the first pulley portion. An armature for connection about the engine shaft is adapted for threaded connection to one of the first or second pulley portions. A stator coil for positioning adjacent the armature causes rotation of the armature when energized so that rotation of the armature with respect to the pulley, in response to energization of the stator coil during use, changes the axial spacing between the first and second pulley portions.

According to another aspect of the present invention, a method for electrically actuating a continuously variable transmission having first and second pulleys interconnected by a belt is provided. The first pulley is adapted for mounting on an engine shaft and has a first pulley portion and an axially movable second pulley portion. An armature is provided adjacent the engine shaft so as to normally rotate therewith and is rotatably coupled to the first or second pulley portion so as to move one pulley portion axially with respect to the other pulley portion in response to relative rotation between the armature and the pulley. A stator coil is provided adjacent the armature. Energizing the stator coil to cause the armature to rotate relative to the pulley changes the axial spacing between the first and second pulley portions.

According to a further aspect of the present invention, an electrically actuated continuously variable transmission has a first pulley with a first pulley portion for fixed connection to an engine shaft and an axially movable second pulley portion for placement about the engine shaft. An electric actuator coaxially coupled to the second pulley portion moves the second pulley portion with respect to the first pulley portion when the electric actuator moves the second pulley portion to change the spacing between the first and second pulley portions.

### BRIEF DESCRIPTION OF THE DRAWINGS

FIG. 1 is a perspective view of a continuously variable transmission of the prior art at a lower speed ratio.

FIG. 2 is a perspective view of a continuously variable transmission of the prior art at a higher speed ratio.

FIG. 3 is a cross-sectional view of an embodiment of a coaxially mounted electrical actuator in accordance with the present invention, in a lower speed ratio configuration.

FIG. 4 is a cross-sectional view of the electrical actuator of FIG. 3, shown in a higher speed ratio configuration.

FIG. 5 is a cross-sectional view of another embodiment of a coaxially mounted electrical actuator in accordance with of the present invention.

FIG. 6 is a cross-sectional view of the electrical actuator of FIG. 5, shown in a higher speed ratio configuration.

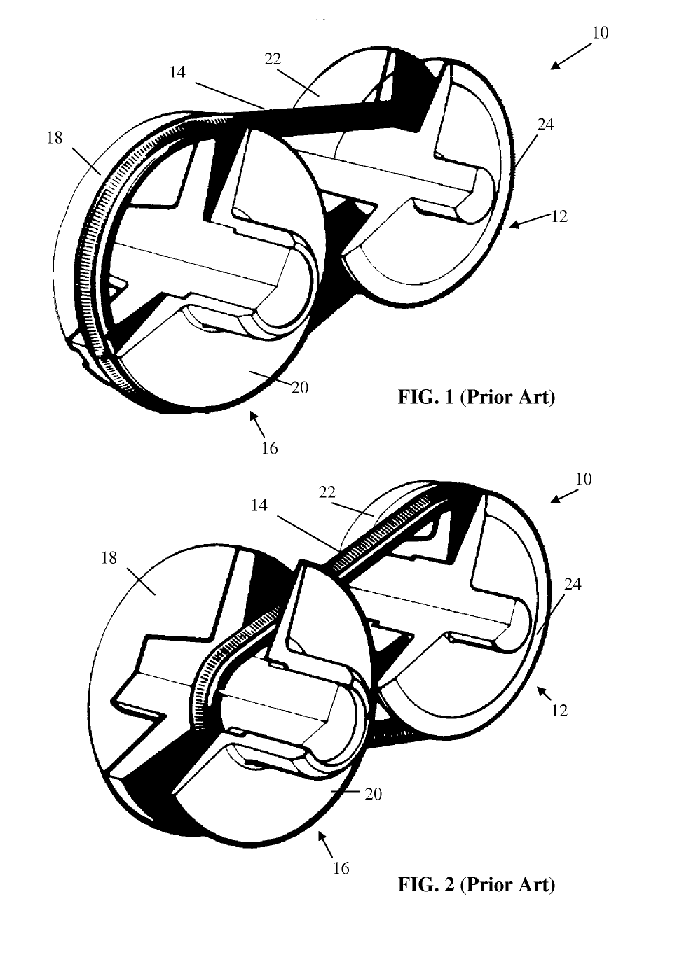

### DETAILED DESCRIPTION OF THE PREFERRED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

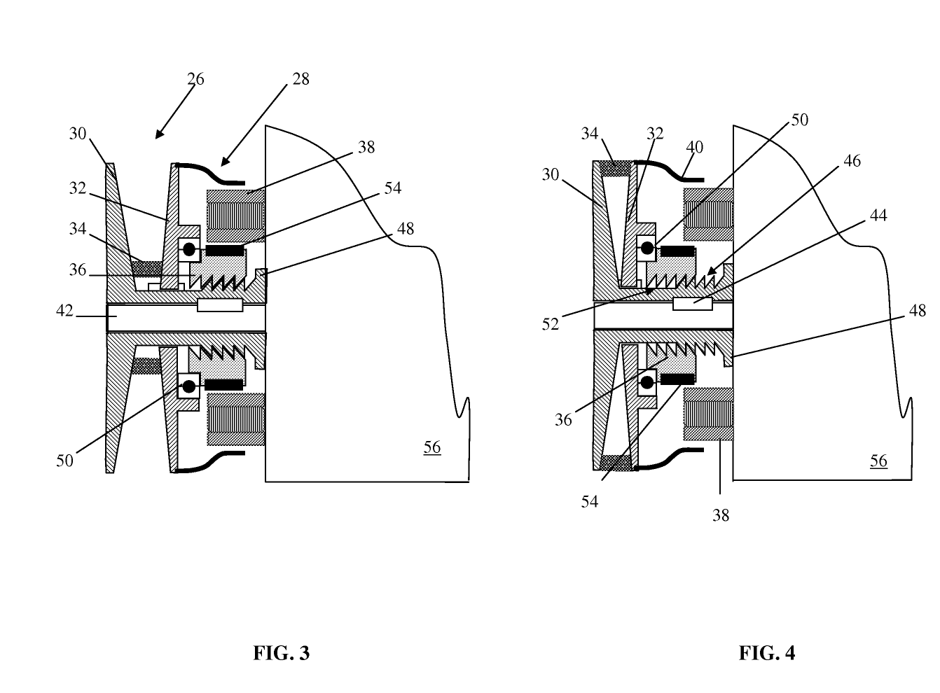

FIGS. 3 and 4 show a pulley 26 and a coaxially mounted electrical actuator 28 for a continuously variable transmission (CVT) in accordance with one embodiment of the present invention. The pulley has a fixed pulley half or portion 30 and a movable pulley half or portion 32 interconnected by a belt 34. The electrical actuator includes an armature 36 and a stator coil 38. A cover 40 connected to the movable pulley half 32 protects the coaxially mounted electrical actuator.

The fixed pulley half 30 is fixedly connected to the engine shaft 42, such as with a key 44, and has an externally threaded, preferably self-locking pitch, collar portion 46 and an armature stop 48. The movable pulley half is positioned about the engine shaft, adjacent the fixed pulley half. Movement of the movable pulley half 32 is effected by movement of the armature or rotor 36, which is connected to movable pulley half 32 by way of a thrust bearing 50. During a shift operation of the transmission, the threaded portion 46 of the fixed pulley half 30 co-acts with rotation of the armature 36 to move the movable pulley half 32 with respect to the fixed pulley half 30 to change the speed ratio of the transmission. The armature stop 48 limits movement of the movable pulley half 32 with respect to the fixed pulley half 30, setting the maximum low speed ratio of the transmission.

The armature or rotor 36 shown in the FIGS. 3 and 4 includes a nut mounted on the fixed pulley half 32 and normally spins at the same rate as the engine shaft 42. The armature nut has an internally threaded, preferably self-locking pitch, portion 52 which mates with the threaded portion 46 of the fixed pulley half 30. The armature 36 has a magnetized portion 54 and, together with stator 38, forms an electric motor coaxially mounted on the engine shaft.

The stator coil 38 is fixed to an external wall of the engine 56. During a shift operation, it is selectively energized to create an alternating electrical field that acts upon the magnetized portion 54 of the armature 36, causing it to rotate with respect to the threaded portion 46 of the fixed pulley half 30. Such relative motion causes the movable pulley half 32 to move toward or away from the fixed pulley half 30, depending upon the direction of rotation of the armature 36. Movement of pulley half 32 toward fixed pulley half 30 decreases the spacing between the pulley halves, which forces the belt 34 toward the outer edge of the pulley, as shown in FIG. 4, effectively increasing the speed ratio of the transmission. Movement of pulley half 32 away from fixed pulley half 30 increases the spacing between the pulley halves and allows the belt to move toward the center of the pulley, as shown in FIG. 3, effectively decreasing the speed ratio of the transmission.

Alternating electric current may be continuously supplied to the stator coil 38 during a shift operation to either slow down or speed up the rotation of the armature relative to the engine shaft and the fixed pulley. Alternatively, electric current may be supplied to the stator coil 38 in appropriately timed pulses to incrementally move the armature 36, e.g., in stepwise fashion. When power is removed from the stator coil 38, the movable pulley half 32 preferably remains stationary with respect to the fixed pulley half 30, due in part to the self-locking thread connection between the threaded portion 46 and the armature nut 36. This reduces power consumption of the coaxial electrical actuator 28, as well as stator coil heating, because actuation of the stator coil 38 is only required when change of the speed ratio is desired.

The CVT incorporating the present invention may be operated in open-loop fashion, e.g., by energizing the stator coil as a simple function of engine speed or, in certain embodiments, simply by means of suitable control switches connected to the stator coil. Alternatively, an electronic control system is provided which is responsive to engine speed and throttle position. Such an electronically controlled CVT may operate open-loop but preferably operates as a closed-loop control system responsive to feedback indicative of the actual state of the transmission, which may be measured, for example, in terms of the position of the movable pulley.

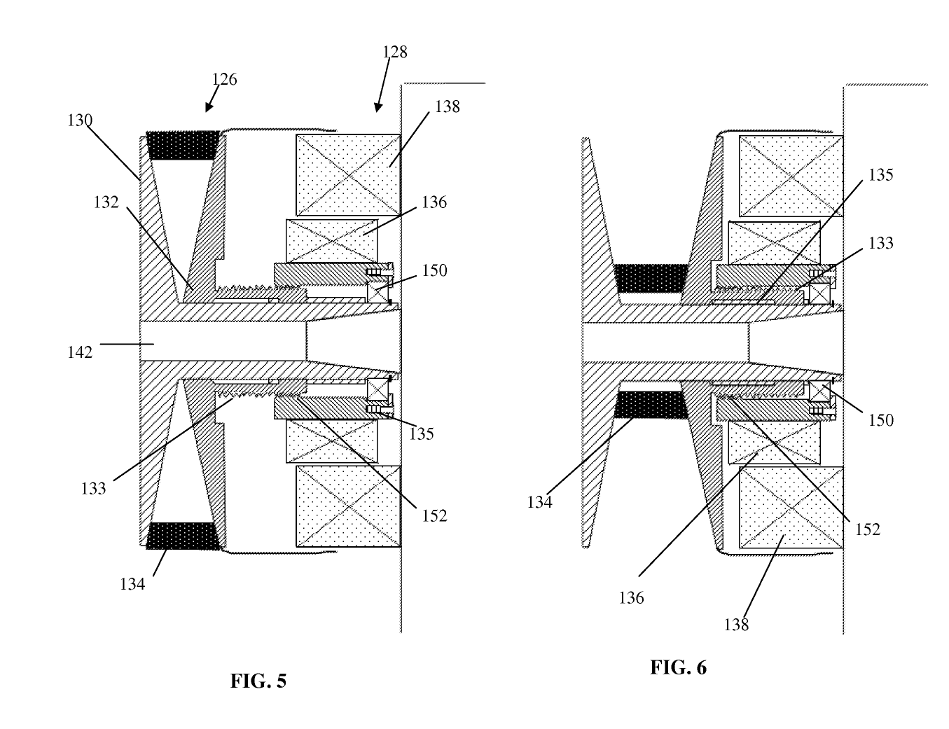

In another embodiment of the present invention providing a coaxially mounted electrical actuator 128 for a pulley 126 of a continuously variable transmission, shown in FIGS. 5 and 6, the movable pulley half 132 has an externally threaded sleeve or collar portion 133 that is in threaded communication with the internal threads 152 of the armature nut or rotor 136. It will be understood by those skilled in the art that sleeve portion or collar 133 is nonrotatable, i.e., not capable of rotating, with respect to the belt-engaging portion of pulley half 132. The two pulley halves 130 and 132 are splined together 135 to rotate at the same speed at all times, and to allow the engine shaft 142 to transmit its torque to both pulley halves 130 and 132. The armature nut 136 is in communication with the fixed pulley half 130 by way of a thrust bearing 150 and normally spins with the rotation of the engine shaft 142. Manipulation of the alternating electric field of the stator coil 138 so that the armature nut 136 spins faster or slower than the engine shaft 142 rotation will cause the movable pulley half 132 to move axially toward or away from the fixed pulley half 130. Movement of the movable pulley half 132 forces the belt 134 to move toward the outer edges of the pulley halves 130 and 132, as shown in FIG. 5, or toward the center of the pulley halves 130 and 132, as shown in FIG. 6, altering the speed ratio of the transmission.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. For example, while a threaded connection is described above for the armature and the pulley, unthreaded connections are also contemplated. One such actuator comprises an electric solenoid, e.g., a three-position or other multi-position solenoid, mounted on an external wall of the engine with its longitudinal axis parallel to the engine shaft and with its plunger coupled to the movable pulley half so as to move the pulley half in response to an electrical signal.

Another form of electric actuator may include an electromagnetic actuator as in a loudspeaker, e.g., with a magnetic collar about the engine shaft coupled to an electromagnetic coil fixed to the engine. The magnetic collar may, for example, be similar to the armature of FIG. 3 but without threads (coupled to an unthreaded sleeve that is otherwise like threaded sleeve 46 on the fixed pulley of FIG. 3), and the fixed electromagnetic coil may be similar to the stator of FIG. 3. Other forms of linear electric actuators are also contemplated, such as linear stepper motors.

The electrical actuator of the present invention may also be used in other ways, such as, for example, a starter motor for an internal combustion engine. The armature may be moved toward the engine, effectively disengaging the movable pulley from the belt, and contacting the armature stop so as to apply torque directly to the engine shaft, turning the engine shaft for starting. The electrical actuator may also be used as a power source—as an auxiliary electric motor or in certain applications as the primary electric motor—in a hybrid vehicle of the type that uses an electric motor and internal combustion engine to power the vehicle. For example, the electric actuator may be sized to provide significant drive torque to the transmission pulley to augment the torque used to drive the vehicle.

I claim:

1. An electrically actuated continuously variable transmission (CVT), comprising:
first and second variable-diameter pulleys mechanically linked by a flexible drive member, each of said pulleys having first and second relatively axially movable pulley portions; and
an electrical actuator having first and second relatively axially movable parts coaxially mounted to said first pulley.

2. The electrically actuated CVT of claim 1, wherein said first portion of said first pulley has a threaded collar.

3. The electrically actuated CVT of claim 2, wherein said first part of said electrical actuator is a stator and said second part of said electrical actuator is a rotor, and wherein said rotor engages said threaded collar.

4. A method of electrically actuating a continuously variable transmission having first and second pulleys mechanically linked by a flexible drive member, said first pulley coupled to an engine shaft and having a first pulley portion and an axially movable second pulley portion, and an electrical actuator coaxial with said first pulley and having a first part mechanically coupled to one of said pulley portions, said method comprising:
causing said first part of said electrical actuator to rotate at a nominal speed corresponding to the current running speed of said one pulley portion during transmission operation when not changing the speed ratio of said transmission; and
moving said second pulley portion axially with respect to said first pulley portion to change the speed ratio of said transmission by energizing said electrical actuator such that said first part thereof rotates above said nominal speed for a shift in one direction and below said nominal speed for a shift in the opposite direction;
wherein said first part of said electrical actuator is axially movable with respect to said first pulley portion.

5. The method of claim 4, wherein said first part of said electrical actuator has a threaded portion which engages mating threads monolithically formed on said first pulley portion.

6. The method of claim 5, wherein said first part of said electrical actuator includes a rotor which rotates within a stator mounted on the housing of an engine with which said transmission is used.

7. The method of claim 6, wherein said first pulley and said electrical actuator are mounted on said engine shaft.

8. An electrically actuated continuously variable transmission (CVT), comprising:
a first pulley having a first pulley portion for fixed connection to an engine shaft and an axially movable second pulley portion for placement about the engine shaft;
a threaded collar, coaxial and nonrotatable with respect to said first pulley portion; and
an electric actuator coaxially coupled to said second pulley portion, having a rotor that is threadedly engaged with said threaded collar and axially movable with respect to said first pulley portion.

9. The electrically actuated CVT of claim 8, further comprising:
a second pulley adjacent said first pulley; and
a belt connecting said first and second pulleys.

10. The electrically actuated CVT of claim 9, wherein said collar and first pulley portion are of unitary construction.
